(19) United States
(12) Patent Application Publication
(10) Pub. No.: US 2009/0059581 A1
(43) Pub. Date: Mar. 5, 2009

(54) Display Device

(76) Inventors: Keiji Hayashi, Mie (JP); Kentaro Kamada, Mie (JP)

Correspondence Address: HARNESS, DICKEY & PIERCE, P.L.C., P.O. BOX 8910, RESTON, VA, 20195, US

(21) Appl. No.: 12/083,679

(22) PCT Filed: Aug. 25, 2006
(86) PCT No.: PCT/JP2006/316684

§ 371 Date: Apr. 17, 2008

(30) Foreign Application Priority Data
Feb. 27, 2006 (JP) 2006-50618

(51) Int. Cl. G09G 3/36; F21V 33/00; F21K 7/00

(52) U.S. Cl. 362/234; 362/231; 345/102

(57) ABSTRACT

In one embodiment of the present invention, a liquid crystal panel includes a plurality of R sub-pixels that transmit red light, and a plurality of GB sub-pixels that transmit green and blue light. An R backlight emits red light continuously, whereas a G backlight for emitting green light and a B backlight for emitting blue light glow intermittently at mutually exclusive times, each backlight glowing once within one screen display period. A circuit for driving the liquid crystal panel drives the R sub-pixels based on a video signal, and the GB sub-pixels based on either a video signal selected in accordance with the glowing of the G backlight and the B backlight. Red blinking is prevented in such a manner, thereby preventing photosensitive epilepsy. Thus, it is possible to achieve a display device that provides a bright display screen without any adverse effect on the physical condition of humans.

### TECHNICAL FIELD

The present invention relates to display devices for effecting a color display, such as liquid crystal display devices.

### BACKGROUND ART

Most of the liquid crystal display devices for effecting a color display include a color filter having light of a specific color transmitted per sub-pixel. However, the color filter liquid crystal display devices have a problem where most of the light transmitted through a liquid crystal panel is absorbed by the color filter, resulting in a dark display screen. To solve this problem, field sequential liquid crystal display devices for effecting a color display without using any color filter are known.

FIG. 11 is a block diagram illustrating the configuration of a conventional field sequential liquid crystal display device. In FIG. 11, a liquid crystal panel 91 includes (m×n) pixels P, and is driven by a display control circuit 92, a scanning signal line drive circuit 93, and a data signal line drive circuit 94. Three types of backlights 97r, 97g, and 97b are connected to a power supply circuit 95 via a switch 96, and when supplied with a power supply voltage, they emit red light, green light, and blue light, respectively.

The liquid crystal display device shown in FIG. 11 is supplied with three video signals Vr, Vg, and Vb. Also, in this liquid crystal display device, one screen display period (one frame period) is divided into three parts: the first to third sub-frame periods (see FIG. 12). For example, when the length of one frame period is 1/60 of a second, the length of each sub-frame period is 1/180 of a second. In the first sub-frame period, the liquid crystal panel 91 is driven based on the video signal Vr and the R backlight 97r glows. In the second sub-frame period, the liquid crystal panel 91 is driven based on the video signal Vg and the G backlight 97g glows. In the third sub-frame period, the liquid crystal panel 91 is driven based on the video signal Vb and the B backlight 97b glows.

Therefore, the pixels P included in the liquid crystal panel 91 appear red at an intensity corresponding to the video signal Vr in the first sub-frame period, green at an intensity corresponding to the video signal Vg in the second sub-frame period, and blue at an intensity corresponding to the video signal Vb in the third sub-frame period. Thus, by shortening the length of the sub-frame periods, it becomes possible to effect a color display.

Field sequential liquid crystal display devices as described above have an advantage over color filter liquid crystal display devices in that no light is absorbed by the color filter, resulting in a bright display screen. In addition, color filter liquid crystal display devices require an opaque TFT (thin film transistor) to be provided per sub-pixel, but field sequential liquid crystal display devices require the TFT to be provided only per pixel. Therefore, if the color filter type and the field sequential type are equal in their pixel and TFT sizes, the field sequential type provides a brighter display screen because the area of the liquid crystal panel that is occupied by the TFTs is smaller.

Note that Patent Document 1 discloses as a technology relevant to the claimed invention of the present application a display device for effecting a color display by sequentially causing a plurality of light sources to glow, the light sources emitting light of their respective different colors, in which while one light source is glowing, other light sources glow with a predetermined amount of light in order to enhance color reproducibility.

[Patent Document 1] Japanese Laid-Open Patent Publication No. 2003-280607

### DISCLOSURE OF THE INVENTION

### Problems to be solved by the Invention

Incidentally, when viewing a display screen with blinking video or light, humans might have feelings of discomfort, resulting in epilepsy (referred to as “photosensitive epilepsy”) on rare occasions. This symptom is known to be most likely when viewing vivid red blinking.

However, in conventional field sequential liquid crystal display devices, the three types of backlights 97r, 97g, and 97b glow intermittently for the length of one sub-frame period at mutually exclusive times. In addition, when displaying a red screen, the light transmittance of the liquid crystal panel 91 is 100% in the first sub-frame period, and 0% in the second and third sub-frame periods, as shown in FIG. 13. Therefore, in reality, the red screen appears red for the length of one sub-frame time, and black for the length of two sub-frame times. As such, the red screen provided by conventional field sequential liquid crystal display devices includes red blinking, which is the greatest factor that induces photosensitive epilepsy.

Accordingly, conventional field sequential liquid crystal display devices have a problem where humans might suffer photosensitive epilepsy when a red screen is being displayed. This problem could arise not only in the case of liquid crystal display devices of the field sequential type but also in the case of LED (light emitting diode) display devices and EL (electro luminescence) display devices of the same type.

Therefore, an objective of the present invention is to provide a display device that provides a bright display screen without any adverse effect on the physical condition of humans.

### Solution to the Problems

A first aspect of the present invention is directed to a display device for effecting a color display, comprising:
a first light source for emitting a first color;
a second light source for emitting a second color;
a third light source for emitting a third color;
a display panel including a plurality of first sub-pixels that transmit light of the first color, and a plurality of second sub-pixels that transmit light of second and third colors; and
a drive circuit for driving the display panel based on first to third video signals,
wherein the first light source glows continuously, whereas the second and third light sources glow intermittently at mutually exclusive times, and
wherein the drive circuit drives the first sub-pixels based on the first video signal, and the second sub-pixels based on either the second or third video signal selected in accordance with the glowing of the second and third light sources.

In a second aspect of the present invention, based on the first aspect of the invention, each of the second and third light sources glows once within one screen display period.

In a third aspect of the present invention, based on the first aspect of the invention, the amounts of light emitted per unit time when the second and third light sources glow are greater than the amounts of light emitted per unit time by the second and third light sources when the first through third light sources glow at the same time to obtain synthetic light of a predetermined color.

In a fourth aspect of the present invention, based on the first aspect of the invention, the first color is red, the second color is green, and the third color is blue.

In a fifth aspect of the present invention, based on the first aspect of the invention, the drive circuit drives the first sub-pixels with the same frequency as the second sub-pixels.

In a sixth aspect of the present invention, based on the first aspect of the invention, the drive circuit drives the first sub-pixels with a lower frequency than the second sub-pixels.

In a seventh aspect of the present invention, based on the first aspect of the invention, the first and second sub-pixels have pixel apertures of the same size.

In an eighth aspect of the present invention, based on the first aspect of the invention, the first and second sub-pixels have pixel apertures of different sizes.

In a ninth aspect of the present invention, based on the first aspect of the invention, the display panel includes a color filter having a portion that transmits the light of the first color and a portion that transmits the light of the second and third colors.

In a tenth aspect of the present invention, based on the first aspect of the invention, the display panel is a liquid crystal panel.

An eleventh aspect of the present invention is directed to a method for driving a display device for effecting a color display, the method comprising the steps of:
causing a first light source for emitting a first color to glow continuously, while causing a second light source for emitting a second color and a third light source for emitting a third color to glow intermittently at mutually exclusive times; and
driving a display panel based on first to third video signals, the display panel including a plurality of first sub-pixels that transmit light of the first color, and a plurality of second sub-pixels that transmit light of the second and third colors,
wherein in the step of driving the display panel, the first sub-pixels are driven based on the first video signal, and the second sub-pixels are driven based on either the second or third video signal selected in accordance with the glowing of the second and third light sources.

### Effect of the Invention

According to the first or eleventh aspect, the first sub-pixels appear as the first color at an intensity corresponding to the first video signal, and the second sub-pixels appear as the second color at an intensity corresponding to the second video signal or the third color at an intensity corresponding to the third video signal. Thus, it is possible to correctly effect a color display using the display panel including the first and second sub-pixels. In addition, because the first light source glows continuously, it is possible to prevent any adverse effect of a display screen including blinking of the first color on the physical condition of humans. For example, if the first color is red, it is possible to prevent red blinking, which is the greatest factor that induces photosensitive epilepsy, thereby preventing photosensitive epilepsy, which may be caused by field sequential display devices. Moreover, because the amount of light absorbed by the display panel is lower than in conventional color filter liquid crystal display devices, a brighter display screen is provided.

According to the second aspect, the second sub-pixels appear as the second color and the third color, once for each color within one screen display period, and therefore it is possible to correctly effect a color display using the display panel including the first and second sub-pixels.

According to the third aspect, the amounts of light emitted by the second and third light sources are increased compared to the case where the three types of light sources glow at the same time to obtain synthetic light of a predetermined color, making it possible to attain a balance among the amounts of light emitted from the light sources, thereby correctly effecting a color display even when the time for which the first light source glows is longer than the time for which each of the second and third light sources glows.

According to the fourth aspect, the first light source for emitting red light glows continuously, making it possible to prevent red blinking, which is the greatest factor that induces photosensitive epilepsy, thereby preventing photosensitive epilepsy.

According to the fifth aspect, the first sub-pixels are driven with the same frequency as the second sub-pixels, making it possible to combine the circuit for driving the first sub-pixels and the circuit for driving the second sub-pixels, resulting in a simplified circuit.

According to the sixth aspect, the time for which the circuit for driving the first sub-pixels operates is reduced compared to the case where the first sub-pixels are driven with the same frequency as the second sub-pixels, thereby reducing power consumption of the device.

According to the seventh aspect, the structure of the display panel is simplified, making it possible to facilitate design and manufacture of the display panel, resulting in a reduction in manufacturing cost of the display device.

According to the eighth aspect, it is possible to attain a balance among the amounts of light transmitted through the sub-pixels, thereby correctly effecting a color display regardless of the amounts of light emitted from the light sources.

According to the ninth aspect, a color filter is provided to obtain a display panel including the first sub-pixels that transmit the light of the first color and the second sub-pixels that transmit the light of second and third colors.

According to the tenth aspect, it is possible to achieve a color liquid crystal display device that provides a bright display screen without any adverse effect on the physical condition of humans.

### BRIEF DESCRIPTION OF THE DRAWINGS

FIG. 1 is a block diagram illustrating the configuration of a liquid crystal display device according to an embodiment of the present invention.

FIG. 2 is a schematic cross-sectional view of a liquid crystal panel in the liquid crystal display device shown in FIG. 1.

FIG. 3 is a layout diagram illustrating the configuration of pixel electrodes of the liquid crystal panel in the liquid crystal display device shown in FIG. 1.

FIG. 4 is a time chart showing the times at which backlights glow in the liquid crystal display device shown in FIG. 1.

FIG. 5 is another layout diagram illustrating the configuration of pixel electrodes of the liquid crystal panel in the liquid crystal display device shown in FIG. 1.

FIG. 6 is a diagram showing the light transmittance of the liquid crystal panel when the liquid crystal display device shown in FIG. 1 displays a red screen.

FIG. 7A is a diagram showing a characteristic of a portion of a color filter that transmits red light as used in conventional color filter liquid crystal display devices.

FIG. 7B is a diagram showing a characteristic of a portion of the color filter that transmits green light as used in conventional color filter liquid crystal display devices.

FIG. 7C is a diagram showing a characteristic of a portion of the color filter that transmits blue light as used in conventional color filter liquid crystal display devices.

FIG. 8A is a diagram showing a characteristic of a portion of a color filter that transmits red light as used in the liquid crystal display device shown in FIG. 1.

FIG. 8B is a diagram showing a characteristic of a portion of the color filter that transmits green and blue light as used in the liquid crystal display device shown in FIG. 1.

FIG. 9 is a block diagram illustrating the configuration of a liquid crystal display device according to a variant of the embodiment of the present invention.

FIG. 10 is a block diagram illustrating the configuration of a liquid crystal display device according to another variant of the embodiment of the present invention.

FIG. 11 is a block diagram illustrating the configuration of a conventional field sequential liquid crystal display device.

FIG. 12 is a time chart showing the times at which backlights glow in the liquid crystal display device shown in FIG. 11.

FIG. 13 is a diagram showing the light transmittance of a liquid crystal panel when the liquid crystal display device shown in FIG. 11 displays a red screen.

### DESCRIPTION OF THE REFERENCE CHARACTERS

10, 40, 50 liquid crystal display device

11, 41, 51 liquid crystal panel

12, 42, 52 display control circuit

13 scanning signal line drive circuit

14, 44, 54 data signal line drive circuit

15 power supply circuit

16, 56 switch

17r, 17g, 17b, 17c backlight

21 polarizing plate

22 glass substrate

23a, 31 pixel electrode

23b opposing electrode

24 oriented film

25 liquid crystal

26 color filter

32 TFT

33, G1 to Gn scanning signal line

34, S1a to Sma, S1b to Smb, S1c to Smc data signal line

Vr, Vg, Vb, Vc video signal

X1, X2 backlight control signal

### BEST MODE FOR CARRYING OUT THE INVENTION

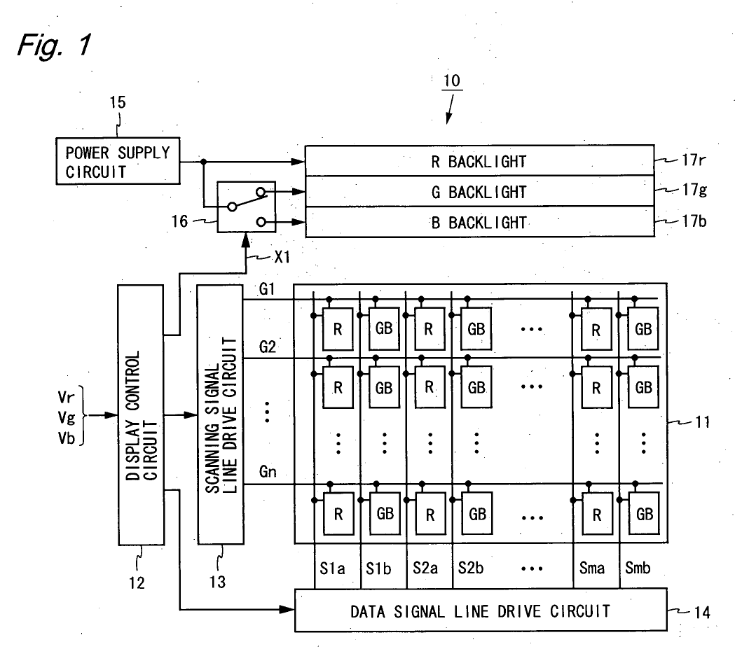

FIG. 1 is a block diagram illustrating the configuration of a liquid crystal display device according to an embodiment of the present invention. The liquid crystal display device 10 shown in FIG. 1 includes a liquid crystal panel 11, a display control circuit 12, a scanning signal line drive circuit 13, a data signal line drive circuit 14, a power supply circuit 15, a switch 16, and three types of backlights (an R backlight 17r, a G backlight 17g, and a B backlight 17b) and effects a color display based on (m×n) pixels. Hereinafter, m and n are each an integer of 1 or higher.

The liquid crystal panel 11 includes (2m×n) sub-pixels (indicated by rectangles labeled “R” or “GB”), n scanning signal lines G1 to Gn, and 2m data signal lines S11a to Smb, as shown in FIG. 1. The sub-pixels are disposed such that 2m of them are arranged in the row direction (the horizontal direction in the figure), and n of them are arranged in the column direction (the vertical direction in the figure). The scanning signal lines G1 to Gn are disposed in the order: G1, G2, . . . , Gn, while the data signal lines S1a to Smb are disposed in the order: S1a, S1b, S2a, S2b, . . . , Sma, Smb. Sub-pixels disposed in the same row are commonly connected to any one of the scanning signal lines G1 to Gn. Sub-pixels disposed in-the same column are commonly connected to any one of the data signal lines S1a to Smb.

The liquid crystal display device 10 is supplied with three video signals Vr, Vg, and Vb corresponding to three primary colors of light. The display control circuit 12, the scanning signal line drive circuit 13, and the data signal line drive circuit 14 drive the liquid crystal panel 11 based on the three video signals Vr, Vg, and Vb. More specifically, the display control circuit 12 generates timing control signals required for driving the liquid crystal panel 11. The scanning signal line drive circuit 13 sequentially selects and activates the scanning signal lines G1 to Gn based on a timing control signal (e.g., a gate clock GCK) generated by the display control circuit 12. The data signal line drive circuit 14 applies voltages corresponding to the video signal Vr to the data signal lines S1a to Sma, and voltages corresponding to the video signal Vg or Vb to the data signal lines S1b to Smb, based on a timing control signal (e.g., a source clock SCK) generated by the display control circuit 12.

The backlights 17r, 17g, and 17b are light sources for irradiating the back of the liquid crystal panel 11 with light, and when supplied with a power supply voltage from the power supply circuit 15, they emit light of their respective different colors. More specifically, when supplied with the power supply voltage, the R backlight 17r emits red light, the G backlight 17g emits green light, and the B backlight 17b emits blue light. For example, CCFLs (cold cathode fluorescent lamps) or LEDs are used as the backlights 17r, 17g, and 17b.

The R backlight 17r is directly connected to the power supply circuit 15. Accordingly, while the liquid crystal display device 10 is operating, the R backlight 17r glows continuously. On the other hand, the G backlight 17g and the B backlight 17b are connected to the power supply circuit 15 via the switch 16. The display control circuit 12 generates a periodically-changing backlight control signal X1, in addition to the timing control signals to be supplied to the scanning signal line drive circuit 13 and soon. The switch 16 alternately connects the power supply circuit 15 to the G backlight 17g or the B backlight 17b in accordance with the backlight control signal X1. Accordingly, while the liquid crystal display device 10 is operating, the G backlight 17g and the B backlight 17b glow intermittently at mutually exclusive times.

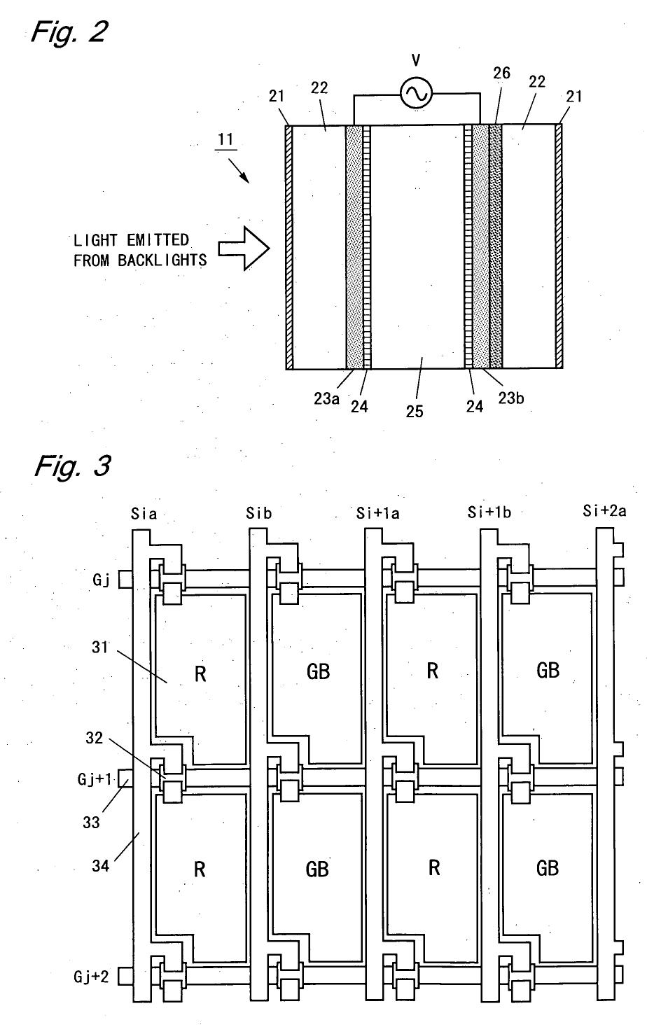

FIG. 2 is a schematic cross-sectional view of the liquid crystal panel 11. Similar to conventional liquid crystal panels, the liquid crystal panel 11 is structured by polarizing plates 21, glass substrates 22, a pixel electrode 23a, an opposing electrode 23b, and a liquid crystal 25 provided between oriented films 24. In the liquid crystal panel 11, the light transmittance (the rate at which incident light is transmitted) of a portion filled with the liquid crystal 25 changes in accordance with a voltage V applied between the pixel electrode 23a and the opposing electrode 23b. A screen display is effected by taking advantage of this property.

The liquid crystal panel 11 is provided with a color filter 26 in order to transmit light of a specific color (or to absorb a specific color(s)) per sub-pixel. The color filter 26 has portions for transmitting red light (in order words, for absorbing green and blue light), and portions for transmitting green and blue light (in other words, for absorbing red light). Note that in the example shown in FIG. 2, the color filter 26 is provided on the opposing electrode 23b side (more specifically, between the opposing electrode 23b and the glass substrate 22), but the color filter 26 can be provided on the pixel electrode 23a side.

FIG. 3 is a layout diagram illustrating the configuration of pixel electrodes provided on one glass substrate of the liquid crystal panel 11. Formed on the glass substrate of the liquid crystal panel 11 are pixel electrodes 31, TFTs 32, scanning signal lines 33, and data signal lines 34, as shown in FIG. 3. The pixel electrodes 31 are each connected to the data signal line 34 via the TFT 32, and a control terminal of the TFT 32 is connected to the scanning signal line 33.

The pixel electrodes 31 are classified into those connected to any one of the data signal lines S1a to Sma, and those connected to any one of the data signal lines S1b to Smb (hereinafter, the former is referred to as “R pixel electrodes”, and the latter is referred to as “GB pixel electrodes”). The color filter 26 transmits red light through the portions that cover the R pixel electrodes, and green and blue light through the portions that cover the GB pixel electrodes. Therefore, the R pixel electrodes function as pixel apertures of the sub-pixels appearing red (hereinafter, referred to as “R sub-pixels”), except any portion covered with a non-transmissive material, such as an insulating layer, whereas the GB pixel electrodes function as pixel apertures of the sub-pixels appearing green and blue (hereinafter, referred to as “GB sub-pixels”), except any portion covered with the non-transmissive material.

A half of the (2m×n) sub-pixels included in the liquid crystal panel 11 are R sub-pixels, and the remaining half are GB sub-pixels. The liquid crystal panel 11 effects a color display based on the (m×n) pixels using the (m×n) R sub-pixels and the (m×n) GB sub-pixels.

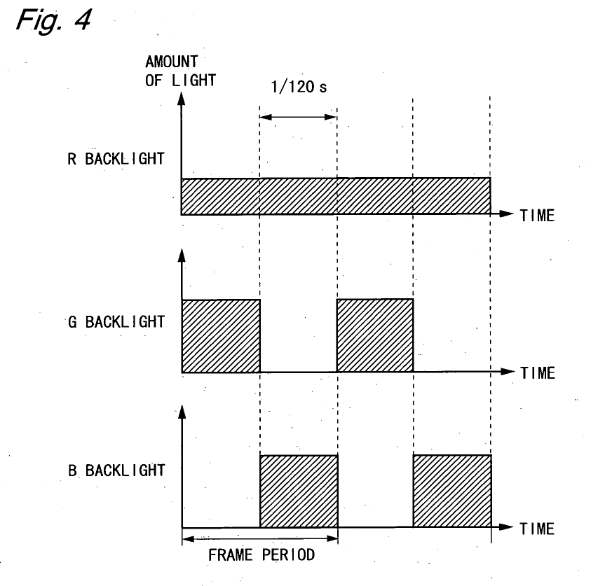

FIG. 4 is a time chart showing the times at which the backlights glow in the liquid crystal display device 10. In the liquid crystal display device 10, one screen display period (one frame period) is divided into two parts: the first sub-frame period, and the second sub-frame period. For example, when the length of one frame period is 1/60 of a second, the length of each sub-frame period is 1/120 of a second.

The display control circuit 12 generates the backlight control signal X1, for example, the level of which is low during the first sub-frame period, and high during the second sub-frame period. The switch 16 connects the power supply circuit 15 to the G backlight 17g when the backlight control signal X1 is at low level, and to the B backlight 17b when the backlight control signal X1 is at high level. Accordingly, the R backlight 17r glows in both the first and second sub-frame periods, whereas the G backlight 17g and the B backlight 17b glow only in the first sub-frame period and the second sub-frame period, respectively, as shown in FIG. 4. As such, the R backlight 17r glows continuously, whereas the G backlight 17g and the B backlight 17b glow intermittently at mutually exclusive times, each backlight glowing once within one screen display period.

In addition, a drive circuit constituted by the display control circuit 12, the scanning signal line drive circuit 13, and the data signal line drive circuit 14 drives the R sub-pixels based on the video signal Vr, and the GB sub-pixels based on either the video signal Vg or Vr selected in accordance with the glowing of the G backlight 17g and the B backlight 17b. Concretely, the scanning signal line drive circuit 13 sequentially selects and activates the scanning signal lines G1 to Gn every line time within the first sub-frame period, and it also performs the same operation in the second sub-frame period. The data signal line drive circuit 14 performs dot sequential drive or line sequential drive to apply voltages to the data signal lines S1a to Smb in accordance with the three video signals Vr, Vg, and Vb.

The data signal line drive circuit 14 may drive the GB sub-pixels in one screen display period, once based on the video signal Vg, and once based on the video signal Vb, and it may also drive the R sub-pixels twice based on the video signal Vr (hereinafter, this is referred to as a “first operation”). More specifically, in each line time within the first sub-frame period, the data signal line drive circuit 14 applies voltages corresponding to the video signal Vr for one row to the data signal lines S1a to Sma and voltages corresponding to the video signal Vg for one row to the data signal lines S1b to Smb, whereas in each line time within the second sub-frame period, it applies voltages corresponding to the video signal Vr for one row to the data signal lines S1a to Sma and voltages corresponding to the video signal Vb for one row to the data signal lines S1b to Smb.

In this case, the GB sub-pixels are driven based on the video signal Vg for one screen in the first sub-field period, and based on the video signal Vb for one screen in the second sub-field period. In addition, the R sub-pixels are driven based on the video signal Vr for one screen in the first sub-field period, and they are driven again based on the same video signal Vr for one screen in the second sub-field period. As such, the drive circuit may include the data signal line drive circuit 14 that performs the first operation, and drive the R sub-pixels with the same frequency as the GB sub-pixels.

Instead of performing the first operation, the data signal line drive circuit 14 may drive the GB sub-pixels in one screen display period, once based on the video signal Vg, and once based on the video signal Vb, and it may also drive the R sub-pixels once based on the video signal Vr (hereinafter, this is referred to as a “second operation”). More specifically, in each line time within the first sub-frame period, the data signal line drive circuit 14 applies voltages corresponding to the video signal Vr for half a row to a half of the data signal lines S1a to Sma (e.g., the first half of the data signal lines S1a to Sma when arranged in the order of their additional characters, or odd-numbered lines from among the data signal lines S1a to Sma) and voltages corresponding to the video signal Vg for one row to the data signal lines S1b to Smb, whereas in each line time within the second sub-frame period, it applies voltages corresponding to the video signal Vr for the remaining half of the row to the remaining half of the data signal lines S1a to Sma (e.g., the second half of the data signal lines S1a to Sma when arranged in the order of their additional characters, or even-numbered lines from among the data signal lines S1a to Sma) and voltages corresponding to the video signal Vb for one row to the data signal lines S1b to Smb.

In this case, the GB sub-pixels are driven based on the video signal Vg for one screen in the first sub-field period, and based on the video signal Vb for one screen in the second sub-field period. In addition, the R sub-pixels are driven based on the video signal Vr for one screen divided into the first and second sub-field periods. As such, the drive circuit may include the data signal line drive circuit 14 that performs the second operation, and drive the R sub-pixels with a lower frequency than the GB sub-pixels (here, half the frequency)

As described above, the R backlight 17r glows continuously, and the R sub-pixels for transmitting red light are driven based on the video signal Vr in the first and second sub-frame periods. Accordingly, the R sub-pixels appear red at an intensity corresponding to the video signal Vr in the first and second sub-frame periods. In addition, the G backlight 17g and the B backlight 17b glow intermittently at mutually exclusive times, and the GB sub-pixel for transmitting green and blue light are driven based on the video signal Vg in the first sub-frame period, and based on the video signal Vb in the second sub-frame period. Accordingly, the GB sub-pixels appear green at an intensity corresponding to the video signal Vg in the first sub-frame period, and blue at an intensity corresponding to the video signal Vb in the second sub-frame period. The liquid crystal display device 10 effects a color display in accordance with the method as described above.

The liquid crystal display device 10 is configured to be capable of displaying a white screen in order to correctly effect a color display. Specifically, the liquid crystal display device 10 is configured to display a white screen when the three video signals Vr, Vg, and Vb are at their respective predetermined values (typically, maximum values). To this end, it is necessary to attain a balance among the amount of red light emitted from the R backlight 17r and transmitted through the R sub-pixels, the amount of green light emitted from the G backlight 17g and transmitted through the GB sub-pixels, and the amount of blue light emitted from the B backlight 17b and transmitted through the GB sub-pixels.

The amounts of the three types of transmitted light vary depending on, for example, the brightness of backlight, the time for which the backlight glows, the size of sub-pixel, and the light transmittance of color filter. Accordingly, when designing the liquid crystal display device 10, it is necessary to design the liquid crystal panel 11 and the three types of backlights 17r, 17g, and 17b such that a balance can be attained among the amounts of the three types of transmitted light.

For example, consider a case where three types of backlights that are equal in the amount of light emitted per unit time and provide white light when they glow at the same time are used as the three types of backlights 17r, 17g, and 17b in the liquid crystal display device 10. In this case, if the G backlight 17g and the B backlight 17b glow only half the time for which the R backlight 17r glows, as shown in FIG. 4, the amounts of light per unit time when the G backlight 17g and the B backlight 17b glow are each required to be twice the amount of light emitted per unit time by the R backlight 17r. Generally, in the case where the G backlight 17g and the B backlight 17b glow for a shorter period of time than the R backlight 17r, the amounts of light emitted per unit time when the G backlight 17g and the B backlight 17b glow may be each set to be greater than the amounts of light emitted per unit time by the G backlight 17g and the B backlight 17b when the three types of backlights glow at the same time to provide white light.

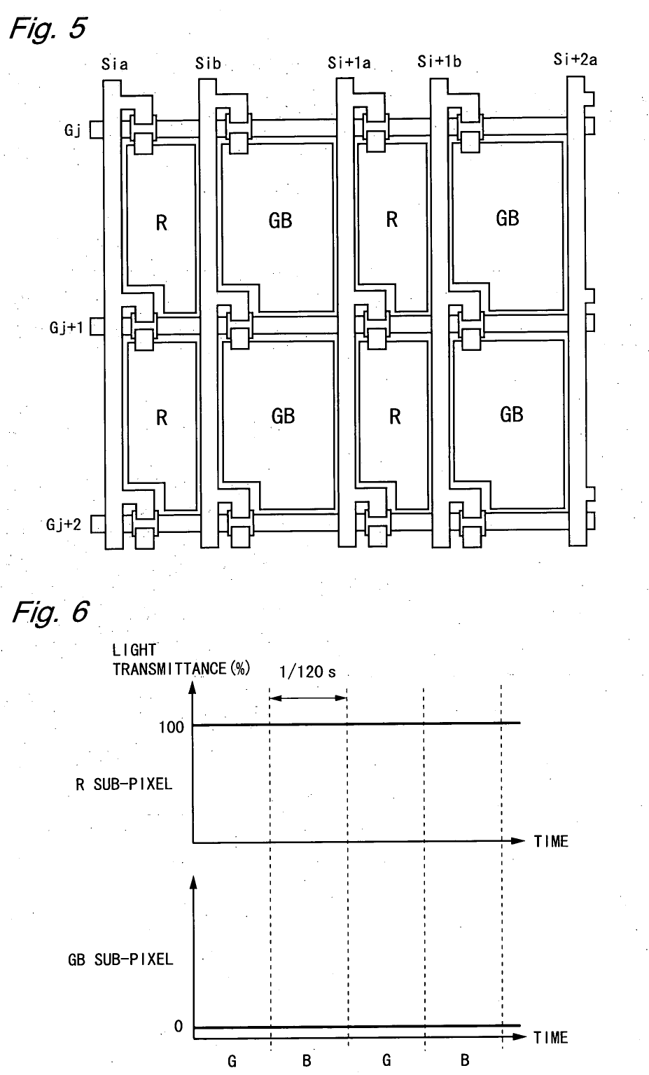

Alternatively, in the example shown in FIG. 3, the R pixel electrodes and the GB pixel electrodes are equal in size, but the R pixel electrodes and the GB pixel electrodes may differ in size, as shown in FIG. 5. As such, the R sub-pixels and the GB sub-pixels may have pixel apertures of either the same size or different sizes.

Effects of the liquid crystal display device 10 will be described below. As described above, the R sub-pixels appear red at an intensity corresponding to the video signal Vr, and the GB sub-pixels appear green at an intensity corresponding to the video signal Vg or blue at an intensity corresponding to the video signal Vb. Accordingly, by suitably shortening the length of the sub-frame periods (e.g., approximately 1/120 of a second), it becomes possible to correctly effect a color display.

In addition, when displaying a red screen on the liquid crystal display device 10, the light transmittance of the liquid crystal panel 11 is 100% for the R sub-pixels and 0% for the GB sub-pixels, as shown in FIG. 6. Therefore, the red screen always appears red without changing to black as in conventional field sequential liquid crystal display devices. As such, the red screen provided by the liquid crystal display device 10 does not include any red blinking, which is the greatest factor that induces photosensitive epilepsy. Accordingly, the liquid crystal display device 10 makes it possible to prevent photosensitive epilepsy.

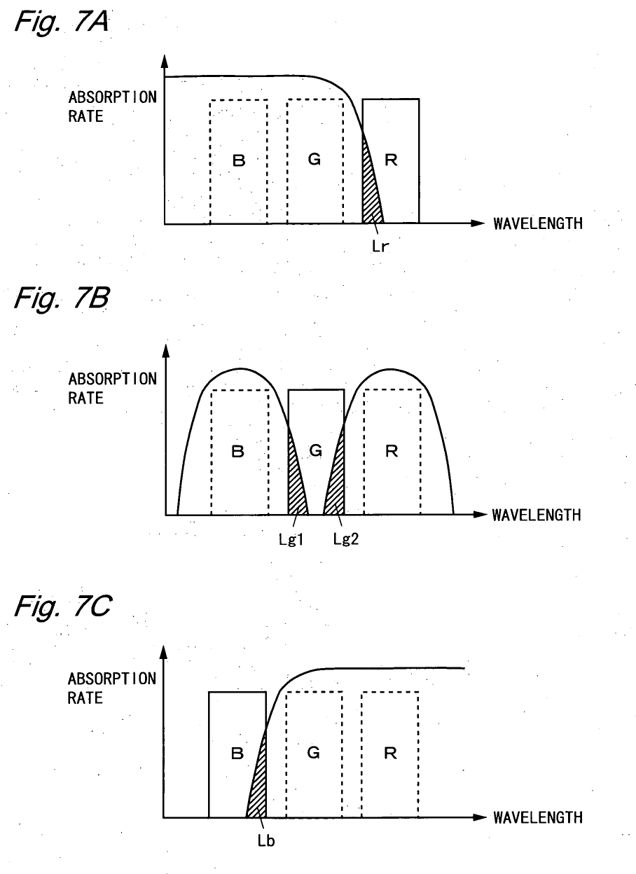

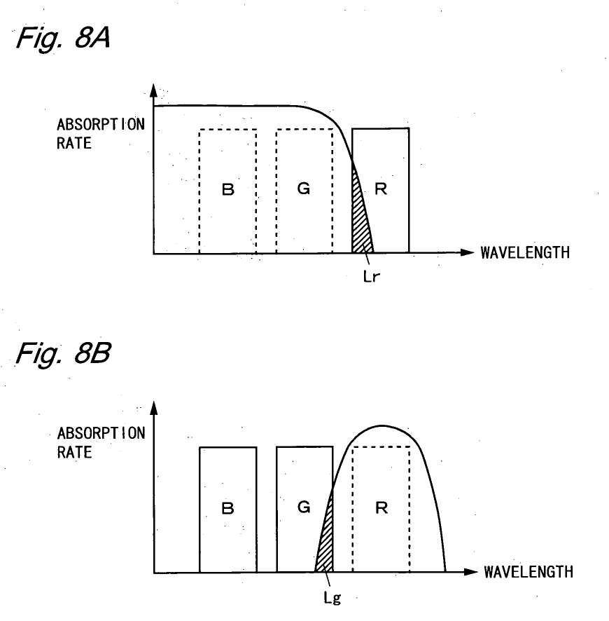

In addition, although the liquid crystal display device 10 includes the color filter 26, it has an advantage in that a display screen is brighter than in conventional color filter liquid crystal display devices. This will be described below with reference to FIGS. 7A to 7C and FIGS. 8A and 8B. FIGS. 7A to 7C are diagrams illustrating characteristics of color filters included in conventional color filter liquid crystal display devices. FIGS. 8A and 8B are diagrams illustrating characteristics of the color filter 26 included in the liquid crystal display device 10.

Conventional color filter liquid crystal display devices are provided with the color filter having the portion that transmits red light and absorbs green and blue light (FIG. 7A), the portion that transmits green light and absorbs red and blue light (FIG. 7B), and the portion that transmits blue light and absorbs red and green light (FIG. 7C). Ideally, the color filter preferably only transmits light of a wavelength within a predetermined range, but in reality, it absorbs portions of the light that should be transmitted (hatched portions in FIG. 7A to FIG. 7C).

Concretely, the portion that transmits red light absorbs a portion (Lr in FIG. 7A) of red components with a short wavelength that are included in light (white light) emitted from the backlights. The portion that transmits green light partially absorbs a portion (Lg1 in FIG. 7B) of green components with a short wavelength that are included in the light emitted from the backlights, and a portion (Lg2 in FIG. 7B) of green components with a long wavelength that are included in the same light. The portion that transmits blue light absorbs a portion (Lb in FIG. 7C) of blue components with a long wavelength that are included in the light emitted from the backlights.

On the other hand, the liquid crystal display device 10 is provided with the color filter 26 having the portion that transmits red light and absorbs green and blue light (FIG. 8A), and the portion that transmits green and blue light and absorbs red light (FIG. 8B). The portion of the color filter 26 that transmits red light absorbs a portion (Lr in FIG. 8A) of red light with a short wavelength emitted from the R backlight 17r. In this regard, the liquid crystal display device 10 is equal to conventional color filter liquid crystal display devices. On the other hand, the portion of the color filter 26 that transmits green and blue light absorbs a portion (Lg in FIG. 8B) of green light with a long wavelength emitted from the G backlight 17g, but it does not absorb either a portion of green light with a short wavelength emitted from the G backlight 17g or blue light emitted from the B backlight 17b.

As is apparent from comparison between FIG. 7A to FIG. 7C and FIGS. 8A and 8B, the liquid crystal display device 10 provides a brighter display screen because the amount of light absorbed by the liquid crystal panel is lower than in conventional color filter liquid crystal display devices.

In addition, by increasing the amounts of light emitted per unit time when the G backlight 17g and the B backlight 17b glow compared to the amounts of light emitted per unit time by the G backlight 17g and the B backlight 17b when the three types of backlights glow at the same time to provide white light (see FIG. 4), it becomes possible to attain a balance among the amounts of light emitted from the three types of backlights 17r, 17g, and 17b, thereby correctly effecting a color display even when the time for which the R backlight 17r glows is longer than the time for which each of the G backlight 17g and the B backlight 17b glows.

In addition, the liquid crystal display device 10 including the data signal line drive circuit 14 that performs the first operation makes it possible to combine the circuit for driving the R sub-pixels and the circuit for driving the GB sub-pixels, resulting in a simplified circuit. Moreover, the liquid crystal display device 10 including the data signal line drive circuit 14 that performs the second operation makes it possible to reduce the time for which the circuit for driving the R sub-pixels operates compared to the case where the R sub-pixels are driven with the same frequency as the GB sub-pixels, thereby reducing power consumption of the liquid crystal display device 10.

In addition, the liquid crystal display device 10 with the R sub-pixels and the GB sub-pixels having pixel apertures of the same size (see FIG. 3) makes it possible to simplify the structure of the liquid crystal panel, thereby facilitating design and manufacture of the liquid crystal panel, resulting in a reduction in manufacturing cost of the liquid crystal display device. Moreover, the liquid crystal display device 10 with the R sub-pixels and the GB sub-pixels having pixel apertures of different sizes (see FIG. 5) makes it possible to attain a balance among the amounts of light transmitted through the sub-pixels, thereby correctly effecting a color display regardless of the amounts of light emitted from the three types of backlights 17r, 17g, and 17b.

As described above, the liquid crystal display device according to the present embodiment can be embodied as a color liquid crystal display device that provides a bright display screen without any adverse effect on the physical condition of humans.

While the foregoing description has been provided with respect to the case where the liquid crystal panel includes the R sub-pixels and the GB sub-pixels, the liquid crystal panel may have a pixel configuration other than this. For example, the liquid crystal panel may include G sub-pixels that transmit green light, and RB sub-pixels that transmit red and blue light. In the case of liquid crystal display devices including such a liquid crystal panel, the G backlight glows continuously, whereas the R backlight and the B backlight glow intermittently at mutually exclusive times. Alternatively, the liquid crystal panel may include B sub-pixels that transmit blue light, and RG sub-pixels that transmit red and green light. In the case of liquid crystal display devices including such a liquid crystal panel, the B backlight glows continuously, whereas the R backlight and the G backlight glow intermittently at mutually exclusive times. Such liquid crystal display devices are suitably used when green blinking or blue blinking have an adverse effect on the physical condition of humans.

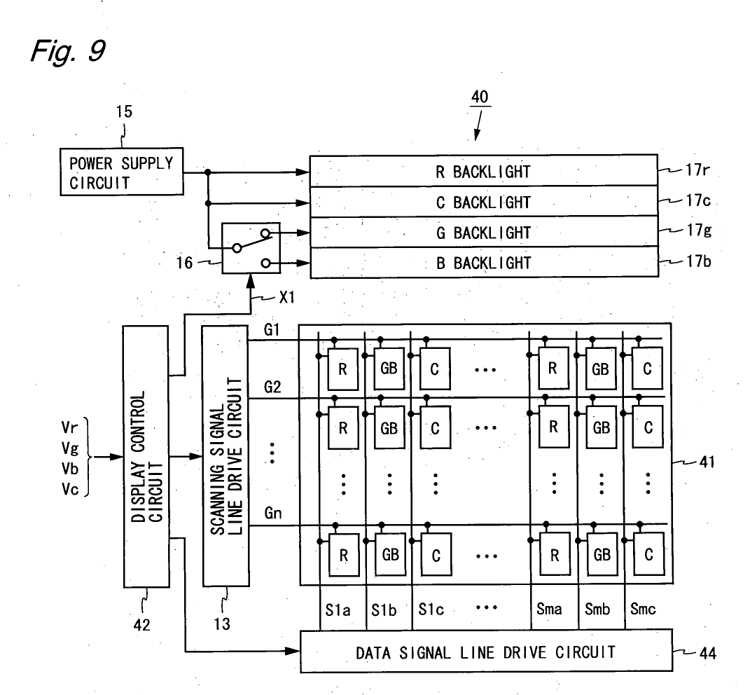

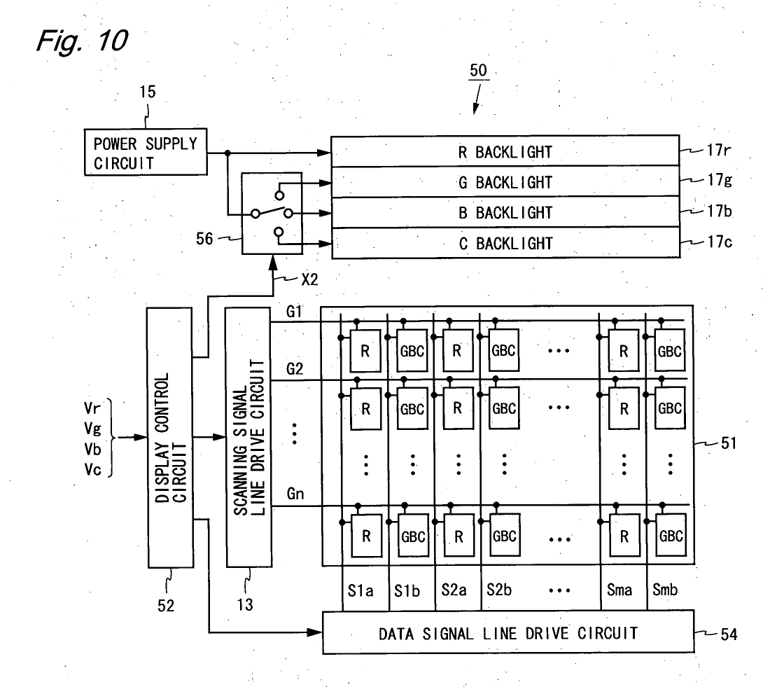

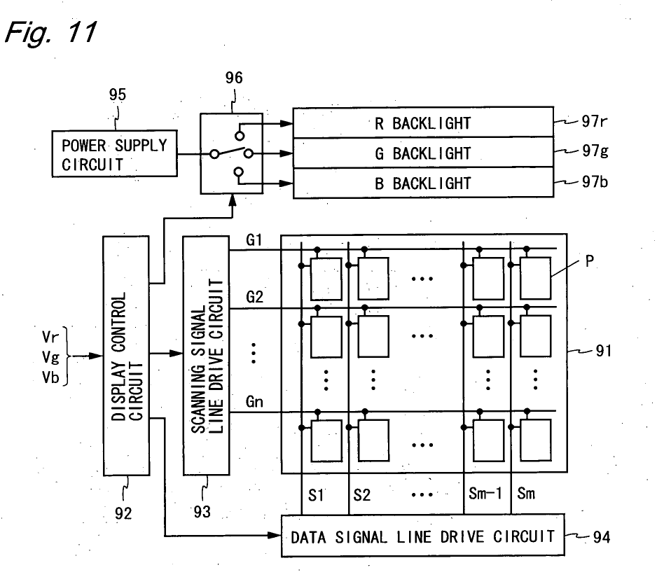

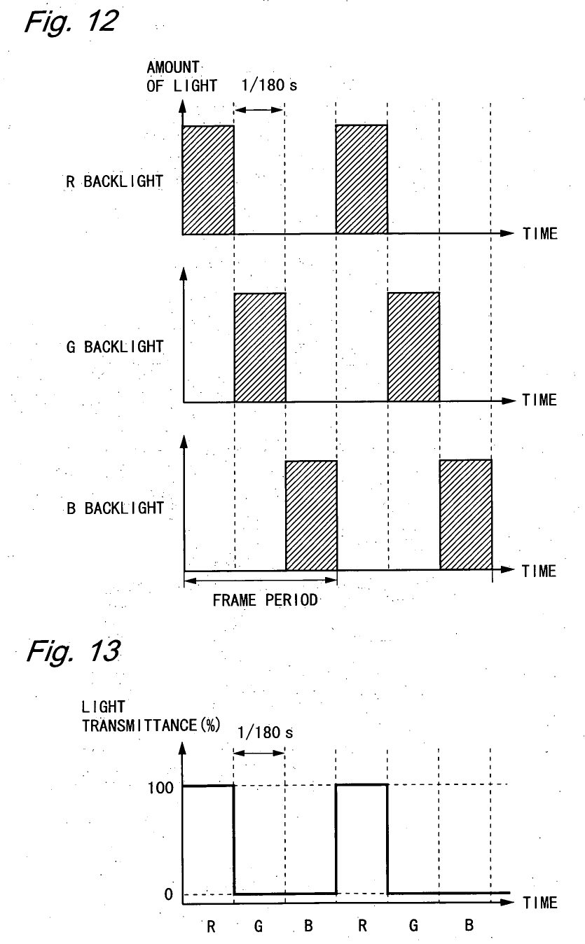

In addition, while the foregoing description has been provided with respect to the case where the liquid crystal display device effects a color display based on the three video signals Vr, Vg, and Vb corresponding to three primary colors of light, the liquid crystal display device may effect a color display based on four or more video signals. FIGS. 9 and 10 are block diagrams each illustrating the configuration of a liquid crystal display device that effects a color display based on four video signals Vr, Vg, Vb, and Vc. Note that the video signal Vc is a video signal representing the intensity of color C other than the three primary colors of light.

The liquid crystal display device 40 shown in FIG. 9 handles the color C in the same manner as red. Concretely, the liquid crystal display device 40 is provided with a C backlight 17c for emitting light of color C, in addition to the three types of backlights 17r, 17g, and 17b, and a liquid crystal panel 41 includes C sub-pixels that transmit the light of color C, in addition to the R sub-pixels and the GB sub-pixels. A drive circuit constituted by a display control circuit 42, the scanning signal line drive circuit 13, and a data signal line drive circuit 44 drives the R sub-pixels based on the video signal Vr, and drives the GB sub-pixels based on the video signal Vg in the first sub-frame time (and based on the video signal Vb in the second sub-frame time), and it also drives the C sub-pixels based on the video signal Vc in the same manner as in the case of the R sub-pixels.

The liquid crystal display device 50 shown in FIG. 10 handles the color C in the same manner as green and blue. Concretely, the liquid crystal display device 50 further includes the C backlight 17c, and a liquid crystal panel 51 includes the R sub-pixels, and GBC sub-pixels that transmit the light of C color in addition to green and blue light. One screen display period is divided into three parts: the first to third sub-frame times, and a display control circuit 52 generates a backlight control signal X2 that has first to third values in the first to third sub-frame times, respectively. A switch 56 alternately connects the power supply circuit 15 to the G backlight 17g, the B backlight 17b, or the C backlight 17c, in accordance with the backlight control signal X2. A drive circuit constituted by the display control circuit 52, the scanning signal line drive circuit 13, and a data signal line drive circuit 54 drives the R sub-pixels based on the video signal Vr, and the GBC sub-pixels based on the video signals Vg, Vb, and Vc in the first to third sub-field periods, respectively.

The liquid crystal display devices shown in FIGS. 9 and 10 have been described as including the C backlight 17c, but instead of using this, the existing backlights 17r, 17g, and 17b may be used in combination so as to emit synthetic light of color C.

As such, the present invention is also applicable to liquid crystal display devices that effect a color display based on four or more video signals. In addition to the liquid crystal display devices, the present invention is also applicable to display devices (e.g., LED display devices and EL display devices) capable of effecting both a hold-type display and an impulse-type display.

### INDUSTRIAL APPLICABILITY

The display device of the present invention achieves the effect of providing a bright display screen without any adverse effect on the physical condition of humans, and therefore it is usable as a liquid crystal display device, as well as an LED display device or an EL display device.

1. A display device for effecting a color display, comprising:
a first light source for emitting a first color;
a second light source for emitting a second color;
a third light source for emitting a third color;
a display panel including a plurality of first sub-pixels that transmit light of the first color, and a plurality of second sub-pixels that transmit light of second and third colors; and
a drive circuit for driving the display panel based on first to third video signals,
wherein the first light source glows continuously, whereas the second and third light sources glow intermittently at mutually exclusive times, and
wherein the drive circuit drives the first sub-pixels based on the first video signal, and the second sub-pixels based on either the second or third video signal selected in accordance with the glowing of the second and third light sources.

2. The display device according to claim 1, wherein each of the second and third light sources glows once within one screen display period.

3. The display device according to claim 1, wherein the amounts of light emitted per unit time when the second and third light sources glow are greater than the amounts of light emitted per unit time by the second and third light sources when the first through third light sources glow at the same time to obtain synthetic light of a predetermined color.

4. The display device according to claim 1, wherein the first color is red, the second color is green, and the third color is blue.

5. The display device according to claim 1, wherein the drive circuit drives the first sub-pixels with the same frequency as the second sub-pixels.

6. The display device according to claim 1, wherein the drive circuit drives the first sub-pixels with a lower frequency than the second sub-pixels.

7. The display device according to claim 1, wherein the first and second sub-pixels have pixel apertures of the same size.

8. The display device according to claim 1, wherein the first and second sub-pixels have pixel apertures of different sizes.

9. The display device according to claim 1, wherein the display panel includes a color filter having a portion that transmits the light of the first color and a portion that transmits the light of the second and third colors.

10. The display device according to claim 1, wherein the display panel is a liquid crystal panel.

11. A method for driving a display device for effecting a color display, the method comprising the steps of:
causing a first light source for emitting a first color to glow continuously, while causing a second light source for emitting a second color and a third light source for emitting a third color to glow intermittently at mutually exclusive times; and
driving a display panel based on first to third video signals, the display panel including a plurality of first sub-pixels that transmit light of the first color, and a plurality of second sub-pixels that transmit light of the second and third colors,
wherein in the step of driving the display panel, the first sub-pixels are driven based on the first video signal, and the second sub-pixels are driven based on either the second or third video signal selected in accordance with the glowing of the second and third light sources.
